(19) United States
(12) Patent Application Publication
(10) Pub. No.: US 2007/0184742 A1
(43) Pub. Date: Aug. 9, 2007

(54) Composite leather material

(75) Inventors: Nancy Susan Coulson, Cary, NC (US); Homan B. Kinsley, Bohannon, VA (US); Joy K. Nunn, Bixby, OK (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignees: Sustainable Solutions, Inc., (SSI) Corp. of Delaware, Tulsa, OK (US); Dow Reichhold Specialty Latex Corp. of Delaware, Durham, NC (US)

(21) Appl. No.: 11/583,677

(22) Filed: Oct. 19, 2006

Related U.S. Application Data
(60) Provisional application No. 60/728,544, filed on Oct. 20, 2005.

(51) Int. Cl. D04H 1/00; B32B 5/24

(52) U.S. Cl. 442/370; 442/414; 442/417

(57) ABSTRACT

Engineered leather substrates, methods of making the substrates, engineered leather composites including the substrates, and articles of manufacture which include the engineered leather substrates or composites are disclosed. The substrate includes leather, non-leather fibers, a binding agent and one or more additional components such as cushioning agents, softeners, processing aids, and colorants. A composite material can be formed including the substrate and one or more additional layers, such as top coat layers, reinforcing layers, and cushioning layers. The substrate and or the composite can be chemically or mechanically embossed. The leather used to form the engineered leather substrate can be derived from post-industrial and/or post-consumer materials. The non-leather fibers can be organic or inorganic, and the composition can also include inorganic fillers, such as calcium carbonate, and clays. The cushioning agents can include polymeric microbubbles, foam, rubber particles, and other low density cushioning agents. The binding agents can be synthetic or natural, such as synthetic latex, natural latex, PVA, and starch.

This application claims benefit of U.S. provisional application No. 60/728,544, filed on Oct. 20, 2005.

### FIELD OF THE INVENTION

The following invention is generally in the field of composite materials, and is more specifically directed to composite materials including leather and a binding agent, which for the purpose of this application will be referred to as an engineered leather substrate.

### BACKGROUND OF THE INVENTION

A variety of consumer goods are prepared from leather, including leather seats, leather apparel, and leather sporting goods. During manufacture, a certain amount of post-industrial waste is produced, as the leather is cut to shape. There is also a certain amount of post-consumer waste generated as leather goods are discarded.

One attempt at providing a composite material including leather and a polymeric binder is disclosed in U.S. Pat. No. 4,162,996. However, the material formed according to the teachings of this patent appears to be somewhat hard and brittle, and, accordingly, has relatively little utility.

It would be advantageous to provide compositions and methods for using the post-industrial and/or post-consumer leather waste and usable to replace leather in a variety of articles of manufacture. The present invention provides such compositions and methods.

### SUMMARY OF THE INVENTION

The present invention is directed to an engineered leather substrate, methods of making the substrate, engineered leather composites including the substrate, and articles of manufacture which include the engineered leather substrate and/or composite.

In addition to leather, the engineered leather substrate includes non-leather fibers, a binding agent and one or more additional components. Representative additional components include cushioning agents, softeners, processing aids, and colorants. A composite material can be formed that includes the substrate and one or more additional layers. Representative additional layers include top coat layers, reinforcing layers, and cushioning layers. The substrate and/or the composite can be chemically or mechanically embossed.

The leather used to form the engineered leather substrate can be in the form of fibers, dust, particles, strips, and the like, and generally falls in the size range of between about 0.1 microns and 50 mm, ideally between about 2 mm and 6 mm. In some embodiments, the leather is derived from post-industrial and/or post-consumer materials.

The non-leather fibers can be organic or inorganic. Examples of organic fibers include, but are not limited to, cellulosic fibers, for example, cotton or wood pulp, polyamides, polyester, polyolefins, and polyurethanes and the like. Examples of inorganic fibers include but are not limited to glass fibers. The composition can also include inorganic fillers, such as calcium carbonate, and clays.

The cushioning agents, which generally comprise between 0 and about 50% by weight of the substrate, are elastomeric materials or provide elastomeric type properties. Such agents include, for example, foam, rubber particles, and other low density cushioning agents.

The binding agents can be synthetic or natural. Examples of binding agents include but are not limited to synthetic latex, natural latex, polyvinyl alcohol (PVA), and starch.

A softener, such as an oil or a humectant can also be present. Processing aids, examples of which include retention aids, flocculants, and the like, can also be present.

The engineered leather substrate can be coated and/or embossed for numerous reasons, depending on the end use application. Suitable coating layers include, but are not limited to, acrylic and/or polyurethane layers. Color coats can be used, and a primer coat can be present between the substrate and the topcoat layer.

The engineered leather substrate can contain a reinforcing material bound to the substrate, or embodied within the substrate, to provide added strength and/or other properties such as additional softness. This can be done during the wet-lay process or post-processing through the use of adhesives that are water based, 100% solids, UV and moisture cure, hot melt, and the like. Representative reinforcing materials include scrims, woven and non-woven materials, films, metal meshes or sheets, and the like.

The layers can be dyed and/or embossed, chemically and/or mechanically, to provide the composite material with a variety of designs including, but not limited to, geometrics, animal prints, floral designs, and the like, for reasons of aesthetics, functionality, or other end use requirements.

Ideally, the engineered leather substrate exhibits less shrinking when formed than is observed when other known processes for producing leather materials are used. The leather substrate also advantageously provides desirable acoustical properties, for example, sound insulation, absorption, reflection, and deflection.

In some embodiments, the engineered leather substrate can be thermally and/or vacuum molded into desired end-products.

The engineered leather substrate and/or the composite material formed from this substrate can be used in virtually all applications for which leather itself is used. Examples include, but are not limited to, leather seats, car interiors, briefcases, apparel, furniture, and the like.

### DETAILED DESCRIPTION

The present invention will be better understood with reference to the following detailed description. The various components of the engineered leather substrate, and composite materials, including the substrate and topcoat layers, reinforcing layers, and/or adhesives, are discussed in detail below.

The resulting engineered leather substrate and resulting composite are unique materials. Examples of the uniqueness of the materials include, but are not limited to, lighter weight material than traditional leather, manufacturing efficiencies (utilizing existing equipment with reduced waste), and flexibility of design for multiple end-use applications. In certain embodiments, the engineered leather substrate and resulting composite can provide strategic acoustic properties, improved softness, breathability, and conformability.

The original manufacturer of the leather used to form the composite material can obtain a cost benefit, because landfill and/or incineration costs are reduced. The manufacturer of the engineered leather substrate and resulting composites also obtains a cost benefit because the material cost is reduced, and the engineered leather substrate can be used in a finished three-dimensional part or application.

I. Substrate

The engineered leather substrate includes leather, non-leather fibers, and a binding agent. In addition, the substrate includes one or more additional components. Examples of these components are described in more detail below.

Leather

The leather can be from virtually any source of leather, including virgin materials, post-industrial materials, and post-consumer materials. Examples of post-consumer and post-industrial materials include, but are not limited to, shoes, fabrics, furniture, office products, clothing, automotive applications, sporting goods, recreational vehicles, construction materials, aircraft, tack, and the like. The sources of leather can also include blue shavings, tanning shavings, split hide waste, reject/off specification hides (irregulars and seconds), buffing powder, pattern trim, binder waste, die cut waste, and sewing waste.

The leather sources include virgin material and animal hides, including cow, ostrich, elephant, alligator, kangaroo, snake, lizard, and the like. Kangaroo leather is unique in that it actually tends to get stronger when it gets thinner, although it also tends to be a relatively expensive leather. In some embodiments, engineered leather materials and regenerated leather material can also be used. The particle size of the leather is generally in the range of about 0.1 microns to 50 millimeters overall, ideally between about 2 and about 6 mm, and less than about 25 millimeters. The size of the leather particles is from about 0.1 micron to about 50 mm. The particles typically have a length of from 1-7 mm, but fine particles can also be used. The particles need not be of a constant diameter. They can be flattened/layered to achieve substantially constant thickness (i.e., no more than about 25% variance in thickness).

If the source of the leather fibers is known, it is possible to track these fibers through the process to the composite material and products formed from the composite material. As a result, it is possible to trace the fibers in the end product back to their source.

Non-Leather Fibers

In addition to the leather, the composition also includes additional fibers (“non-leather fibers”). When the composite leather material does not include such other fibers, the resulting material may not be optimal. One purpose of these other fibers is to provide breathability, porosity, strength, binding, processability, fire retardancy, and/or improved insulation properties to the composite material. Like the binding agents, these fibers are an integral part of a wet process for making sheet goods.

The non-leather fibers can be organic and/or inorganic, and can be derived from post-industrial, virgin, and/or post-consumer fibrous materials. Representative examples include cellulosic materials, polymeric materials, and glass-like materials. The other fibers are typically in the range of between about 1 and about 50% by weight of the fibers (leather fibers and other fibers), between about 5 and about 30% by weight of the fibers, or between about 5 and about 20% by weight of the fibers.

In one embodiment, the other fibers are post-industrial regenerated natural fibers which include, but are not limited to, cotton, wood, hemp and jute. In other embodiments, the fibers can include synthetics, such as polyester, nylon, acrylics, polyamides, polyolefins such as polyethylene and polypropylene, polyethers, and aramids.

Depending on the characteristics of the desired application, the fibers range in size from nano to coarse deniers and lengths from 0.1 micron to 3 inch. These fibers most typically come from post-industrial sources as well. Representative natural fibers which can be added include hemp, jute, and kenaf.

Certain of these fibers can provide fire retardancy, moisture management, strength, flexibility, drape and the like. Higher amounts of specific “non-leather fibers” tend to increase the stiffness of the composite materials, whereas higher amounts of other “non-leather fibers” tend to increase the softness of the composite materials. The stiffness and/or softness can be ascertained using standard ASTM, FLTM, SAE, or other assays for stiffness and softness. Representative assays include, for example, FLTM BN 157-01 (leather softness), ASTM D 2208 and D 571 (breaking strength), ASTM D 5733 (tear strength), FLTM BN 105-03 (shrinkage), SAE J948 (abrasion resistance), ISO 188, ATMS E 145, ISO 105-A02, ASTM D 683, AATCC-Process 1, and ISO R 527-Type 2 (resistance to heat aging), ASTM D 747 (stiffness), ISO 3795 and SAE J 369 (flammability). One of skill in the art can readily select an appropriate amount of a certain other fiber based on desired properties for a given end-use for the composite leather material. Using the assays described above, one can readily ascertain whether the engineered leather substrate and/or composite materials including the substrate have various desired properties.

Representative natural materials include cotton, wood, wool, silk, hemp, and jute, Due to the large amount of cotton used in industrial textile processing, a significant amount of post-industrial cotton is available as a waste stream, and, accordingly, is a relatively inexpensive material. Opened, cut, and refined cellulose and cotton fiber can act to strengthen or soften the substrate. Certain natural fibers may require refining before blending with the leather.

Representative synthetic materials include polyester, nylon, acrylics, polyamides, polyolefins such as polyethylene and polypropylene, polyethers, and the like. Due to the large amount of synthetics used in industrial processing of textiles, a significant amount of post-industrial synthetic material is available as a waste stream, and, accordingly, is a relatively inexpensive material. The addition of these fibers can contribute to other unique characteristics of the composite material. These characteristics are ideally measured by ASTM or other assay standards described herein, which vary depending on the end-use of the product. The amount of the other fibers vary depending on the unique characteristics of the product required to achieve the desired properties of the end-product including the composite leather material.

Cushioning Agents and Fillers

The cushioning agents allow the material to have properties, such as softness and resiliency, that mirror those of some natural leathers. If the composite leather material is to be used for wall coverings, footwear or other similar applications, a cushioning agent may not be required.

In addition to providing resiliency, the cushioning agents can provide additional functions such as enhanced acoustics, conformability and/or slip resistance. The amount of the cushioning agents ranges from 0 to about 50%, in another embodiment, between about 1 and about 25%, and in a third embodiment, between about 5 and about 15%.

As used herein, the terms “elastomeric” and “cushioning agent” encompass particles formed of an elastomer, including, but not limited to, other particles that act elastomeric by virtue of their compression/expansion behavior under stress even if the polymers themselves are not truly classified as elastomers.

In one embodiment, the cushioning agent is in the form of microspheres, which can be hollow, pre-expanded, or expandable microspheres. In another embodiment, finely ground particles of rubber, foam, plastics, latex, and the like, ideally in the size range of 15-150 microns, can be used

The elastomeric agents provide the composite material with some degree of flexibility, and can also provide other benefits such as resiliency, acoustic properties, opacity, and the like. They are, however, specifically used in the leather substrates to provide some degree of beneficial rebound or memory effects.

In many applications, inorganic fillers are an integral part of the formulation. The fillers help to minimize the overall cost of the formulations, and provide other functions as well. The other functions include reinforcement, abrasion resistance, fire retardancy, noise reduction, heat resistance, barrier properties, porosity, efficiency in processing, and the like. The fillers can also provide smoothness to the sheet, therefore making it easier to emboss and, therefore, more aesthetically pleasing. They can also alter the porosity. The fillers are typically present in a weight range of from about 0 to about 50 percent, for example, about 0.5 to about 10 percent, and typically about 2 to about 6 percent.

Various “low density materials,” include ceramics and other non-elastomerics such as glass microbubbles, can be used as low density fillers, even if they don't necessarily provide cushioning.

The term “low density engineered materials” includes materials engineered to fall within a size range of from 1 micron to one inch. The particles can have any shape, including spherical, plate-like, non-uniform, and the like. These particles are particularly useful in embodiments where light weight and/or cushioning is desired.

Examples of suitable fillers include talc, mica, clay, titanium dioxide, carbon black, calcium carbonate and other metal carbonates, pigments, ceramic and zirconia microspheres, particulate forms of the 2^{nd} regeneration leather composite described herein, and the like. As used herein, a 2^{nd} regeneration leather composite is formed from the composite material described herein, for example from waste material left over from end-use applications, which is converted to a filler for re-use. As such, the filler formed from the 2^{nd} generation leather composite includes leather, non-leather fibers, binder, and other various components as described herein.

Whether used as cushioning agents or fillers and/or fillers modified to have functional groups and/or surfaces, the particles used can have a variety of shapes. They can range, for example, from non-spherical and/or non-uniform, to predominantly spherical, with a uniform shape. They can have a variable aspect ratio, and can be present in a relatively broad size distribution, so long as the particles provide the desirable properties, as fillers or as cushioning agents.

Certain of the fillers include functional groups (i.e., functionalized fillers), and/or functional surfaces. These functional groups can permit subsequent chemical bonds to be formed, and can provide for various physical and chemical properties. For example, the surface of a filler can be made hydrophilic, hydrophobic, fire retardant, and the like. Examples of suitable functional groups include halo, such as fluoro, hydroxyl, amine, thiol, carboxylic acid, sulfonic acid, amide, olefin, and the like.

Binding Agents

Binding agents help to bind the fillers, fibers and other ingredients in the formulation, and to provide strength and durability. The binding agents can provide an adhesive bond between the leather component and the other fibers, and can also provide structural and/or other characteristics, such as water resistance, to the composite and resulting products that include the composite. The binding agents include anionic, cationic, and non-ionic binders and are typically present in about 3 to about 50%, for example, between about 15 and about 35% by weight, on a dry weight basis.

Examples of suitable binders/binding agents include latex materials, such as butadiene copolymers, acrylates, vinyl-acrylics, styrene-acrylics, styrene-butadiene, nitrile-butadiene, olefin containing polymers, e.g., vinyl acetate-ethylene copolymers, vinyl ester copolymers, halogenated copolymers, e.g., vinylidene chloride polymers. Latex binders, when used, can contain functionality. Any kind of latex can be used, although acrylics may be preferred because they tend to provide good heat and light stability. Representative acrylics include those formed from ethyl acrylate, butyl acrylate methyl (meth)acrylate, carboxylated versions thereof, glycidylated versions thereof, self-crosslinking versions thereof (for example, those including N-methyl acrylamide), and copolymers and blends thereof, including copolymers with other monomers such as acrylonitrile. Natural polymers such as starch, natural rubber latex, dextrin, cellulosic polymers, and the like can also be used. In addition, other synthetic polymers, such as epoxies, urethanes, phenolics, neoprene, butyl rubber, polyolefins, polyamides, polyesters, polyvinylalcohol, and polyesteramides can also be used.

Processing Aids

The type of processing aid, and whether a processing is needed, depends on the nature of the binder. If a cationic polymer is used, an anionic processing aid is required. If an anionic polymer is used, a cationic processing aid is required. Examples of cationic processing aids include cationic polyacrylamides, di/tri valent cations, metal salts, epichlorohydrin-amine adducts such as Kymene®, alum, polyamines, polyethylene imine, polylysine, and other cationic polymers. Processing aids are typically required for wet-laid processes, although the amount can be almost negligible. The amount can typically range from about 0.01 to about 5%.

Optional Additional Components and/or Processes

In addition to the leather, non-leather fibers, binding agent, fillers, and the like discussed above, other additives can be used to provide specific benefits in the end use product. The following optional components can be added separately or as part of the binding agent used in wet processing. Some components can be included into the finished product during post processing, for example, coating, impregnation, saturation, embossing, molding, and the like.

Crosslinkers

Crosslinkers can be used to provide additional strength and durability. Examples include phenolics, melamine formaldehyde (MF) and urea formaldehyde (UF) resins, epoxies, isocyanates, ethylene imines, and metal salts.

Softeners/Flexibilizers

Softeners and/or flexibilizers can be included to provide flexibility and hand to a product. The softeners are provided in ranges of between about 0 and about 30%, and the quantity will depend on the intended use. Examples include glycerine, silicones, plasticizers such as carboxylic acid esters, for example, citric and phthalate esters, lecithin and other phospholipids, oil emulsions, fats, oils, fatty acid and fatty acid derivatives such as epoxidized soybean oil, and fat liquor. Various humectants can also be used, some of which can have softening properties. Examples of humectants include, but are not limited to, propylene glycol, dipropylene glycol, glycerin, hexylene glycol, polyethylene glycol, sorbitol, mannitol, xylitol, urea, hyaluronic acid, lactamide monoethanolamine, acetamide monoethanolamine, and combinations thereof.

Retention and Drainage Aids

These additives can be added to control the aggregate size of the fiber/filler flocculant formed in wet end processes. They can assist in the formation of a sheet form of the composite materials, and also reduce the time it takes to form sheets without leaving significant residues in the water. Examples include cationic polyelectrolytes, cationic latex, metal salts and metal ions such as alum, sodium chloride, and the like, other cationic materials such as epicholorohydrin-amine adducts, e.g., Kymene® products from Hercules, and polyethylene imines.

Water Repellents/Lubricants

These additives can improve the water repellency and water absorbency characteristics of the substrate. Representative examples include wax, silicones, fluorinated materials, hydrocarbon additives, oils and fats.

Water Absorbents

These additives can improve the water-absorbing capability of the substrate. These can be in used addition to, or in place, of hydrophilic fibers as all or part of the other fibers. Examples of such additives include hydrophilic materials, such as polyalcohols, for example polyethylene glycol and polyvinyl alcohol, hydrophilic silicones, polyethers, polycarboxylates, superabsorbent polymers, and the like.

Coloring Agents

These additives provide coloring to the substrate. These include organic and inorganic pigments and dyes, examples of which include phthalocynanine blue, iron oxide, carbon black, indigo, and the like.

Dispersants/Surfactants

These additives can be added to keep the fillers and pigments wetted and well dispersed in the formulation, as well as providing other functional uses such as water absorbency. In wet end processing, they can also control the formation of the sheet. Examples include carboxylate, ethoxylate and sulfonate-based materials, e.g., Tamol® L, Tamol® 731 A, Morcryl® (all from Rohm and Haas).

Chelating Agents

These additives are used to chelate the metal ions in the wet end process. They also help to control the aggregate size and thereby can affect drainage and retention. Examples include EDTA and EDTA derivatives.

Oil Repellants

These are additives that help to improve repellency to oil, fats and greases, and include fluorinated additives such as Scotch Guard®.

Coagulants/Flocculants

A coagulant/flocculant can also be added to the fiber furnish to facilitate flocculation of the particles. Suitable cationic coagulants include alum and/or other polymer high charge coagulants, for example, polycationic (cationic polymers), and mineral salt divalent and trivalent ions, examples of which include calcium and aluminum salts, respectively.

II. Processes for Preparing the Substrate

The process used to prepare the materials is a wet-laid process. In one embodiment, the products are prepared using a single-ply fourdrinier machine. The process is described in more detail below.

The wet laid process involves the formation of a fibrous mat or sheet from an aqueous slurry having a mixture of ingredients that contribute to strength, uniformity, and other sheet related properties important to a specific application. The ingredients in the mixture are chosen to improve processing, e.g., retention aids or some specific property of the finished sheet, such as porosity, softness, water repellency, etc. It is typically a batch process in which all the components are added together at one stage in the process, in a sequential manner, or certain components can be withheld and added at an appropriate point in the process to have the most desirable effect in terms of the formation of the fibrous sheet and its properties.

Typical processes that have been used for this purpose have traditionally been based on papermaking methods, and involve using a fourdrinier or cylinder machines in which the fibrous mat or sheet is formed on a preformed wire mesh, then dried and rolled into a finished rolled good. The thickness of the sheet is controlled by the amount of fiber and other ingredients in the slurry. These sheets can then be post processed using techniques such as calendaring, coating, laminating, bonding, embossing, extrusion, molding, etc., to add other layers or substrates that impart additional properties to the sheet such as strength, impermeability, styling, shape, dimensional stability, etc.

As described in the summary above, the wet end process involves making an aqueous slurry in which a mixture of components is dispersed. This can be done as a batch process in which all of the components are added at the same time in a machine chest fitted with mixing capabilities or certain components may be held and added at the appropriate time and at a specified location (e.g., further downstream from the machine chest) to get the best desired results. In the batch process, one would typically start with water in the machine chest and in a sequential manner the other components can be added while mixing. Normally, this would involve the addition of fibers (e.g., leather, cellulose, cotton, etc.), fillers/pigments and dyes (e.g., talc, carbon black, etc.), binders (such as latex and/or other resins), retention and drainage aids (e.g., alum, bentonite clays, cationic polymers, etc.), wet and dry strength additives (e.g., Kymene®), and other ingredients that add specific functions to the finished product such as softening or cushioning agents (e.g., polymer microspheres, plasticizers, e.g., epoxidized soybean oil), crosslinkers, etc. These ingredients are known to one in the art and are used as needed to impart specific properties to the finished product, such as strength, water repellency, stiffness, flexibility, etc.

Typically, the order of addition is such that the fibers and fillers are added to the water and mixed well before the addition of the binder. In most cases the binder that is used is either anionic or nonionic in character and can only be deposited onto the fiber/filler surface by adding a cationic coagulant (retention/drainage aid) to the above mixture. This results in the formation of fiber/filler/binder flocs or aggregates. The flocculant is usually the last component to be added to the process to get the deposition to take place. All other functional ingredients, such as softeners, crosslinkers, etc., are added prior to the addition of the flocculant. The amount of fibers, fillers, binders and the like which are added depend on the final basis weight or the thickness of the sheet that is to be made. Typically, the solids concentration of the slurry is <3-4%, and is usually decided by the sheet formation process and the desired uniformity of the sheet. These processes are well known to those in the paper making art and have some similarities with other wet laid methods used in nonwovens.

Once the binder has been flocculated using a cationic component, the aggregates formed can be drained to remove the water and the sheet is usually formed on to a wire mesh screen. The turbidity of the water is a good indicator of whether all of the solid material has been retained on the screen. The conventional equipment that is typically used for such a wet end process involves the use of a fourdrinier or a cylinder machine. This is very well known in the paper making industry. The sheet that is formed on the wire is then typically dried over a drum drier and then rolled into sheet goods ready for shipment or post-processing.

The binder can also be cationic in nature, unlike conventional anionic materials, and in such cases the material would have a natural affinity for the negatively-charged fibers and fillers and a cationic retention aid would not be needed. However, there may be a need in such a case to add some anionic retention aids to make sure that a substantial part of the solids are captured effectively on the screen.

In an extension of the wet-end process, the forming wire screen can be made of polyolefins, polyester or other fiber materials that can become part of the sheet and can act as a scrim material that supports the fibrous sheet or mat that has been formed. Such replaceable wire mesh screens that can become part of the formed substrate are known in the art.

The finished sheet can also go through several post processing steps such as calendering, lamination, extrusion, coating, embossing, foaming, molding, etc., to add further layers, modify the surface or attachments (e.g., scrims, plastic extrusion, foam, etc.) that provide specific benefits such as strength, flexibility, dimensional stability, water repellency, etc. This can be done on-line using equipments such as size press, spray coating, laminating, etc., or off-line such as extrusion, embossing, etc. These post- or in-process steps enhance the value and features obtained from the sheet substrate made by the wet end process.

III. Components of the Engineered Leather Composite Structure

In some applications, the engineered leather substrate is coated with one or more topcoat layers. Such layers can improve the durability and or wearability of the material, provide UV protection, and/or provide a color to the material.

The topcoat layer can be formed from any of a variety of suitable materials, including clear or, dyed, transparent, translucent or opaque materials. Examples of materials that can form the topcoat layer include but are not limited to acrylics and polyurethanes available in a variety of forms. Representative forms include solutions, solids, and dispersions.

When the engineered leather substrate is to be colored, the coloring can be applied to the substrate itself, to one or more of the topcoat layers, or both. When applied to the substrate, a primer is ideally used to seal the engineered leather substrate. If one dyes the substrate rather than applying the color in additional layers, it needs to be dyed before any other components are applied. Suitable primers include but are not limited to acrylics, urethanes, and silane-functionalized polymers.

The color can be applied using pigments and dyes. Examples of suitable pigments include carbon black and titanium dioxide. Suitable dyes can include but are not limited to products from the family of dyes that are basic, reactive, or acid dyes

IV. Reinforcing Layers

The reinforcing layers can provide stitchability, strength, stretchability, and hand. The reinforcing layer can be any material that reinforces the substrate sufficiently for its desired end use. Examples include scrims, wovens, knits, non-wovens, solid sheets, films, foams, and the like. These layers can be formed from synthetic or organic fibers, fiberglass, plastics, metals such as steel, aluminum or tin, and other suitable materials. The layers can be applied using a chemical application process, a hot melt process, or a spun lace process, for example, to add drapeability and strength. The backing can be cushioning, such as a needle punch or sheet foam. The thickness and density of the reinforcing layer(s) varies depending on the nature of the end-product.

In order to increase strength, scrim may be supplied to the composite web. Suitable scrim is known in the art and available commercially and may be a plastic material such as nylon, or may be metallic, for example, steel, aluminum or tin. Scrim may be either supplied to the process in which the composite web is formed in which case the composite web is formed in/on the scrim. In another embodiment, the scrim may be adhered to the formed composite web either just as it is formed but before drying, or to a dried composite web using an adhesive.

In order to improve the hand, a crimp can be supplied to the composite. Crimping is known, particularly in the papermaking arts, to improve the hand (feel) of a web and equipment and processes are known in the art for such a purpose.

Other suitable reinforcing materials include microdenier fabric construction, polyurethane or polyolefin foam, latex foam, and hot-melt backing. These can be provided with appropriate chemicals such that, when heated, the layer can provide chemical embossing to the composite material. The substrates can also be chemically and/or mechanically embossed prior to being attached to the leather substrate.

In addition to embossing, the material can be subjected to plating, breathable film application, and/or molding steps.

Adhesives

An adhesive is used to hold the substrate to the reinforcing layer. In some embodiments, the reinforcing layer is itself an adhesive, for example, a polyolefin scrim, in which case, no adhesive is necessary. When an adhesive is necessary, the adhesives can be in the form of a sheet, a scrim, a powder, a liquid, a curable composition, and the like. When provided in liquid form, they can be applied using a variety of methods, for example, knife coating, spray coating, employing a doctor blade, and the like. The adhesives can be curable, such as urethanes, acrylates, epoxies, thermoset, thermoplastic, such as ethylene vinyl acetate (EVA), polyvinyl chloride (PVC) plastisols, and polyolefins, such as polypropylene and polyethylene, hot-melt, pressure-sensitive adhesives, and rubber cement. The adhesive formulations can be 100% solids (i.e., all of the components of the composition are UV-curable, so there are no volatile emissions), water-based, or solvent-based.

Unique Characteristics of the Composite Material

In some embodiments, the material exhibits minimal shrinking, for example, around 5% versus the 40 to 50% observed in traditional leather preparation, such as tanning processes. The other fibers appear to inhibit shrinkage of the regenerated leather, which is an improvement over the results with new leather. The filled nature of the material, in some embodiments, provides sound absorptive properties.

Representative Example

In one representative example, a substrate was formed including, in approximate ranges, leather (47%), nylon (10%), acrylic latex (15%) and epoxidized soybean oil (28%). This composite leather material provided relatively good drapability and tensile strength, and is suitable for use in automotive applications.

V. Articles of Manufacture Including the Composite Material

The engineered leather substrate can be used to prepare articles of manufacture, such as apparel, garments and accessories, furnishings, leather seats, dashboards, and the like in automotive applications, footwear, office supplies, sporting goods and equipment, and entertainment industries.

Representative product applications include, but are not limited to, automotive seating, automotive interiors, home, office, and retail furnishings and accessories, jewelry, belts and suspenders, watch bands, outerwear, footwear, apparel, hats, gloves, crafts and hobbies, saddle and tack, pet accessories, such as leashes, wall and floor coverings, menu covers, book bindings and covers, outdoor gaming equipment and accessories, toiletry kits, wallets, handbags, backpacks, luggage, sports balls, sports headgear, other athletic equipment, duffle bags, sports accessories, hydration bags, binocular and eyeglass cases, game pieces and accessories, camera bags and cases, costumes and novelties, and telecommunication and electronics accessories.

These articles of manufacture can be prepared using the engineered leather substrate and/or composite leather material described herein. Suitable properties needed for each of these articles of manufacture, and the various components needed in each article of manufacture are well known to those of skill in the art. For example, in non-cushioning applications, no cushioning agent is needed. In moldable applications, certain backing materials are needed. If the material is to be stitched, then the backing is typically more than just a scrim.

There are several conventionally known and used assay protocols for determining the properties of leather goods, any of which can be used to analyze and characterize the engineered leather substrate and resulting composite materials. Examples include, for example, ASTM D 6182, which measures bally flex, ASTM D 6182, IUF 470, and ISO 11644, which measures bally flex with finish adhesion. Additional examples include FLTM BN 180-14 (resistance to pilling), FLTM BN 157-01 (softness), ASTM D 1813 (thickness), SAE J323-Method A (cold flexibility), ASTM D 2208 and ASTM D 571 (breaking strength), ASTM D 2208 (elongation), ASTM D 5733 (rear strength), FLTM BN 106-02 (seam fatigue resistance), FLTM BN 105-03 (shrinkage), FLTM BI 109-01 and FLTM BI 110-01 (appearance), ASTM D 523 (gloss), ISO 2411, FLTM BN 151-05, and DVM-0038-IP (bond strength), SAE J948 (resistance to abrasion), SAE J365 (resistance to scuffing), FLTM BO 111-02 (indention and recovery), FLTM BN 103-01 (resistance to migration, staining, and blocking), FLTM BI 106-01 (coating adhesion), FLTM BI 104-01 (water resistance), FLTM BN 108-13 (resistance to scratching), ISO 188, ATMS E 145, ISO 105-A02, ASTM D 683, AATCC-Process 1, and ISO R 527-Type 2 (resistance to heat aging), FLTM BI 160-01 and AATCC-Process 1 (resistance to fade), DVM-00067-MA, ISO 105-A02, and AATCC-Process (xenon arch weather-O-meter), FLTM BI 109-01 (appearance), ASTM D 571 (weight), FLTM BN 119-01 (seam strength), ISO 2411 (adhesion of vinyl film to backing fabric), SAE J 855 (stretch and set), ASTM D 747 (stiffness), FLTM BN 106-02 (seam fatigue resistance), ISO 3795 and SAE J 369 (flammability), SAE J1756 (fogging), ISO 3795 and SAE J369 (flammability), ISO 105-A02 and AATCC-Process 2 (dimensional stability), FLTM BN 112-08, ISO 105-A02, and AATCC Process 1 (soiling and cleanability), FLTM BN 107-01 and AATCC Process 2 (resistance to cleaning agents), FLTM BI 113-01, ISO 105-A02, and AATCC Process 1 (resistance to suntan lotion and insect repellent), FLTM BI 1130-01, ISO 105-A02, and AATCC Process 1 (resistance to water and soap spotting), FLTM BO 131-01 (odor), ISO 105-A02 and AATCC Process 1 (resistance to dynamic exudation), FLTM BI 107-05 (thermal shock for paint adhesion), and FLTM BN 107-01 (cleaning and removal resistance).

### EXAMPLES

The following non-limiting examples are provided to illustrate the invention as described herein, and are not intended to be limiting.

### Example 1

### Engineered Leather Compositions

A series of engineered leather substrates and composites was prepared using the following compositions:

TABLE 1
Regenerated Leather Compositions:

| | | | | | | | | | | | Form. |
|---|---|---|---|---|---|---|---|---|---|---|---|
| Ingredient | Supplier | Form. 1 | Form. 2 | Form. 3 | Form. 4 | Form. 5 | Form. 6 | Form. 7 | Form. 8 | Form. 9 | 10 |
| Regenerated | SSI | 49.5 | 40.3 | 37.3 | 40.3 | 38.5 | 41.8 | 40.0 | 40.3 | 29 | 40.3 |
| Leather | | | | | | | | | | | |
| Refined | Weyer- | 8.1 | 11.5 | 8.1 | | 8.1 | | | 11.5 | | 11.5 |
| Softwood | haeuser | | | | | | | | | | |
| Refined | Weyer- | 3.4 | | 3.4 | | 3.4 | | | | | |
| Hardwood | haeuser | | | | | | | | | | |
| Microspheres | Henkel | 0 | 9.2 | 9.2 | 9.2 | 4.0 | 9.2 | | | | 9.2 |
| DRSL Acrylic | DRSL | 25.5 | 25.5 | 25.5 | 25.5 | 28 | | | 25.5 | 25 | 25.5 |
| Latex* | | | | | | | | | | | |
| DRSL Nitrile | DRSL | | | | | | 29 | 35 | | | |
| Latex** | | | | | | | | | | | |
| Epoxidized | DRSL | 13.5 | 13.5 | 13.5 | 13.5 | 15.0 | 16 | 18 | 13.5 | | 13.5 |
| soybean oil | | | | | | | | | | | |
| (Softener) | | | | | | | | | | | |
| Polyvinyl | Celanese | | | 3.0 | | | | | | | |
| Alcohol | | | | | | | | | | | |
| Cotton | SSI | | | | 11.5 | | | | | | |
| Polyester | Minifibers | | | | | | 4 | 3.7 | | | |
| Glass | Minifibers | | | | | | | 2.7 | | | |
| 100 mesh | | | | | | | | | 9.2 | | |
| EPDM | | | | | | | | | | | |
| Nylon | Minifibers | | | | | | | | | 3 | |
| Lecithin | ALC | | | | | | | | | 9.4 | |
| Needlepunch | | | | | | | | | | | yes |
| backing | | | | | | | | | | | |
| Basis Weight, | | 0.8 | 0.7 | 0.6 | 0.7 | 1.4 | 2.2 | 1.8 | 1.7 | 1.7 | 2.5 |
| oz/sf | | | | | | | | | | | |
| Caliper, mm | | 0.9 | 1.0 | 1.0 | 1.0 | 1.0 | 1.4 | 0.9 | 1.0 | 1.1 | 3.0 |
| Tensile, lbf | | 18.3 | 9.8 | 12.3 | 12.0 | 59 | 19 | 24 | 22.5 | 9 | 113 |
| Elongation, % | | 7.0 | 6.6 | 5.4 | 6.3 | 11 | 13 | 8 | 5.0 | 13.7 | 36 |

*The acrylic latex can vary in monomer composition and functionality, which can provide different glass transition temperatures and other physical and chemical properties, depending on the desired end use. For example, if a relatively stiffer composite material is desired, the latex may include acrylonitrile and/or methyl methacrylate. If a relatively softer composite material is desired, the latex may include butyl acrylate and/or ethyl acrylate.
**The nitrile latex in this example was a carboxylated acrylonitrile/butadiene copolymer, although other nitrile latexes, such as those including styrene, and self-crosslinking versions, such as those including N-methyl acrylamide, can be used.

A series of engineered leather substrates and composites were prepared using the methods described herein, according to the various formulas. As shown in Table 1, the resulting materials had desirable properties that mirror those of the unmodified leather from which they were derived.

In the specification, typical embodiments have been disclosed and, although specific terms are employed, they are used in a generic and descriptive sense and not for purposes of limitation. It should be clearly understood that resort can be had to various other embodiments, aspects, modifications, and equivalents to those disclosed in the claims, which, after reading the description herein, may suggest themselves to one of ordinary skill in the art without departing from the spirit of the present disclosure or the scope of these claims. The following claims are provided to ensure that the present application meets all statutory requirements as a priority application in all jurisdictions and shall not be construed as setting forth the full scope of the latex composition, methods for use of same, and articles incorporating or containing same that are disclosed herein.

1. A composite material comprising:
leather fibers;
a binding agent;
non-leather fibers; and a
cushioning agent.

2. The composite material of claim 1, wherein the leather materials comprise post-industrial or post-consumer waste.

3. The composite material of claim 1, wherein the binding agent is a latex.

4. The composite material of claim 3, wherein the latex is an acrylic latex.

5. The composite material of claim 1, wherein the non-leather fibers comprise cellulose.

6. The composite material of claim 5, wherein the cellulose fibers are cotton fibers.

7. The composite material of claim 1, wherein the cushioning agent comprises polymeric microbubbles.

8. The composite material of claim 1, wherein the cushioning agent comprises foam particles.

9. A composite material comprising:
leather fibers;
a latex binder;
non-leather fibers; and
a cushioning agent.

10. The composite material of claim 9, wherein the leather materials comprise post-industrial or post-consumer waste.

11. The composite material of claim 9, wherein the binding agent is a latex.

12. The composite material of claim 11, wherein the latex is an acrylic latex.

13. The composite material of claim 9, wherein the non-leather fibers comprise cellulose.

14. The composite material of claim 13, wherein the cellulose fibers are cotton fibers.

15. The composite material of claim 9, wherein the cushioning agent comprises polymeric microbubbles.

16. The composite material of claim 9, wherein the cushioning agent comprises foam particles.

17. A composite material comprising:
leather fibers;
a latex binder;
non-leather fibers; and
a reinforcing substrate.

18. The composite material of claim 17, wherein the leather materials comprise post-industrial or post-consumer waste.

19. The composite material of claim 17, wherein the binding agent is a latex.

20. The composite material of claim 19, wherein the latex is an acrylic latex.

21. The composite material of claim 17, wherein the non-leather fibers comprise cellulose.

22. The composite material of claim 21, wherein the cellulose fibers are cotton fibers.

23. The composite material of claim 19, wherein the reinforcing substrate is a scrim, woven, or non-woven material.

24. The composite material of claim 19, wherein the reinforcing agent comprises a foam layer.

25. A composite material comprising:
leather fibers;
a latex binder;
non-leather fibers; and
a topcoat and/or color coat layer.

26. The composite material of claim 25, wherein the leather materials comprise post-industrial or post-consumer waste.

27. The composite material of claim 25, wherein the binding agent is a latex.

28. The composite material of claim 27, wherein the latex is an acrylic latex.

29. The composite material of claim 25, wherein the non-leather fibers comprise cellulose.

30. The composite material of claim 29, wherein the cellulose fibers are cotton fibers.

31. The composite material of claim 29, wherein the topcoat layer is chemically or mechanically embossed.

32. A composite material comprising:
leather fibers;
a latex binder;
non-leather fibers; and
inorganic fillers, where the fillers provide the composite material with fire retardance, noise reduction, low density, enhanced smoothness, easier drainability, abrasion resistance, or stiffness.

33. The composite material of claim 32, wherein the leather materials comprise post-industrial or post-consumer waste.

34. The composite material of claim 32, wherein the binding agent is a latex.

35. The composite material of claim 34, wherein the latex is an acrylic latex.

36. The composite material of claim 32, wherein the non-leather fibers comprise cellulose.

37. The composite material of claim 36, wherein the cellulose fibers are cotton fibers.

38. The composite material of claim 32, wherein the inorganic fillers comprise one or more of talc, mica, clay, titanium dioxide, carbon black, carbonate salts, pigments, ceramic microspheres, or zirconia microspheres.

39. The composite material of claim 32, wherein the inorganic fillers are functionalized fillers.

40. The composite material of claim 32, wherein the inorganic fillers comprise 2^{nd} generation leather composite material.

41. A composite material comprising:
leather fibers;
a latex binder; and
non-leather fibers; wherein the material is provided with mechanical and/or chemical embossing.

42. The composite material of claim 41, wherein the leather materials comprise post-industrial or post-consumer waste.

43. The composite material of claim 41, wherein the binding agent is a latex.

44. The composite material of claim 43, wherein the latex is an acrylic latex.

45. The composite material of claim 41, wherein the non-leather fibers comprise cellulose.

46. The composite material of claim 45, wherein the cellulose fibers are cotton fibers.

47. The composite material of claim 41, further comprising a cushioning agent.

48. The composite material of claim 41, wherein the cushioning agent comprises polymeric microbubbles or foam particles.

49. A composite material comprising:
leather fibers;
a latex binder; and
non-leather fibers; wherein the latex binder is selected to provide heat and/or UV protection to the composite material such that the material can survive exposure to sunlight and temperatures of around 100° F. for a period of three years before the material experiences significant cracking.

50. The composite material of claim 49, wherein the leather materials comprise post-industrial or post-consumer waste.

51. The composite material of claim 49, wherein the binding agent is a latex.

52. The composite material of claim 51, wherein the latex is an acrylic latex.

53. The composite material of claim 49, wherein the non-leather fibers comprise cellulose.

54. The composite material of claim 53, wherein the cellulose fibers are cotton fibers.

55. The composite material of claim 49, further comprising a cushioning agent.

56. The composite material of claim 49, wherein the cushioning agent comprises polymeric microbubbles or foam particles.

57. An article of manufacture comprising a composite material, wherein the composite material comprises leather fibers, a latex binder, and non-leather fibers.

58. The article of claim 57, wherein the leather materials comprise post-industrial or post-consumer waste.

59. The article of claim 57, wherein the binding agent is a latex.

60. The article of claim 59, wherein the latex is an acrylic latex.

61. The article of claim 57, wherein the non-leather fibers comprise cellulose.

62. The article of claim 61, wherein the cellulose fibers are cotton fibers.

63. The article of claim 57, further comprising cushioning agent.

64. The article of claim 63, wherein the cushioning agent comprises polymeric microbubbles or foam particles.
